(19) United States
(12) Patent Application Publication
(10) Pub. No.: US 2002/0104715 A1
(43) Pub. Date: Aug. 8, 2002

(54) Strategic placement of an elevator inspection device based upon system and component arrangement arrangement

(76) Inventors: Vlad Zaharia, Rocky Hill, CT (US); Pedro S. Baranda, Farmington, CT (US)

Correspondence Address: David J. Gaskey, Carlson, Gaskey & Olds, 400 W. Maple, Suite 350, Birmingham, MI, 48009, US

(21) Appl. No.: 09/778,481

(22) Filed: Feb. 7, 2001

(51) Int. Cl. B66B 1/34

(52) U.S. Cl. 187/391; 187/393

(57) ABSTRACT

An elevator system includes an inspection device that provides information regarding a condition of the elevator rope or belt. The inspection device preferably is positioned to inspect an entire portion of the rope or belt that is most likely to wear as the elevator cab travels between chosen locations. In some situations, the inspection device is at a fixed position within an elevator hoistway. In other situations, the inspection device is supported for movement relative to other elevator system components. In one example, the inspection device is supported on the cab and moves with the cab through the hoistway. A variety of factors are considered for determining the portion of the rope or belt that is most likely to wear and the ideal placement of the inspection device relative to the other elevator system components.

### BACKGROUND OF THE INVENTION

This invention generally relates to elevator systems. More particularly, this invention relates to an elevator system having an inspection device strategically placed to monitor the condition of the belt.

Elevator systems typically include a cab for carrying passengers between landings at various levels of a building. A counterweight is typically associated with the cab. The cab and counterweight usually are connected by a rope or belt. A drive mechanism and series of sheaves operate to move the belt, cab and counterweight within a hoistway to achieve the desired elevator operation.

Elevator ropes or belts typically include a plurality of cords, each of which is made up of a plurality of steel strands. In some instances, the steel cords are coated.

Regardless of the total composition of the belt, it is necessary to monitor the condition of the steel strands over time. The nature of an elevator system, including the length of the rope and the forces on the rope during the life of the elevator system, makes it necessary to periodically evaluate the condition of the belt. For example, if one or more of the steel components in the rope become torn or bent, that presents a weak point within the belt, which affects the ability of the belt to carry the loads imposed upon it during elevator operation. Steel belt deterioration can occur as a result of normal wear and tear, impact upon the belt, fatigue, or inadvertent corrosion.

Visual inspection of elevator belts is not thorough enough to detect all possible signs of fatigue within a belt. For example, multiple strands of steel are within a central portion of the belt and are not visible to an individual. Additionally, the arrangement of a belt within a hoistway typically prevents the entire length of the rope from being inspected.

The limitations on the ability to inspect elevator belts typically results in over-design of the belts, which increases the costs of elevator systems. Additionally, belts that are still useful are sometimes discarded because of a suspicion of deterioration even though such condition cannot be verified accurately.

There is a need for an improved arrangement to inspect elevator belts to enhance the reliability of belt condition determinations and improve the economies associated with belt design, maintenance and replacement. This invention addresses those needs by providing a unique arrangement for inspecting elevator belts.

### SUMMARY OF THE INVENTION

In general terms, this invention is an elevator system having an inspection device that provides information regarding a condition of the elevator rope or belt. The inventive system includes an elevator cab and a counterweight. A plurality of sheaves are positioned to direct a rope that couples the cab to the counterweight. An inspection device is positioned relative to the sheaves to provide information regarding the condition of a portion of the rope that is most likely to wear over time.

A plurality of factors preferably are taken into account to determine the ideal location of the inspection device so that the entire portion of the rope that is most likely to wear is inspected upon each pass of the belt by the inspection device. The design and nature of the elevator system dictates the ideal placement of the inspection device. This invention includes a method of determining ideal inspection device placement.

The various features and advantages of this invention will become apparent to those skilled in the art from the following detailed description of the currently preferred embodiments. The drawings that accompany the detailed description can be briefly described as follows.

### BRIEF DESCRIPTION OF THE DRAWINGS

FIG. 1 schematically illustrates an elevator system designed according to this invention.

FIGS. 2A and 2B show a first arrangement of elevator system components including an inspection device placed according to this invention.

FIGS. 3A and 3B show a second arrangement of elevator system components designed according to this invention.

FIGS. 4A and 4B show a third arrangement of elevator components in a system designed according to this invention.

FIGS. 5A and 5B show a fourth arrangement.

FIGS. 6A and 6B show a fifth arrangement.

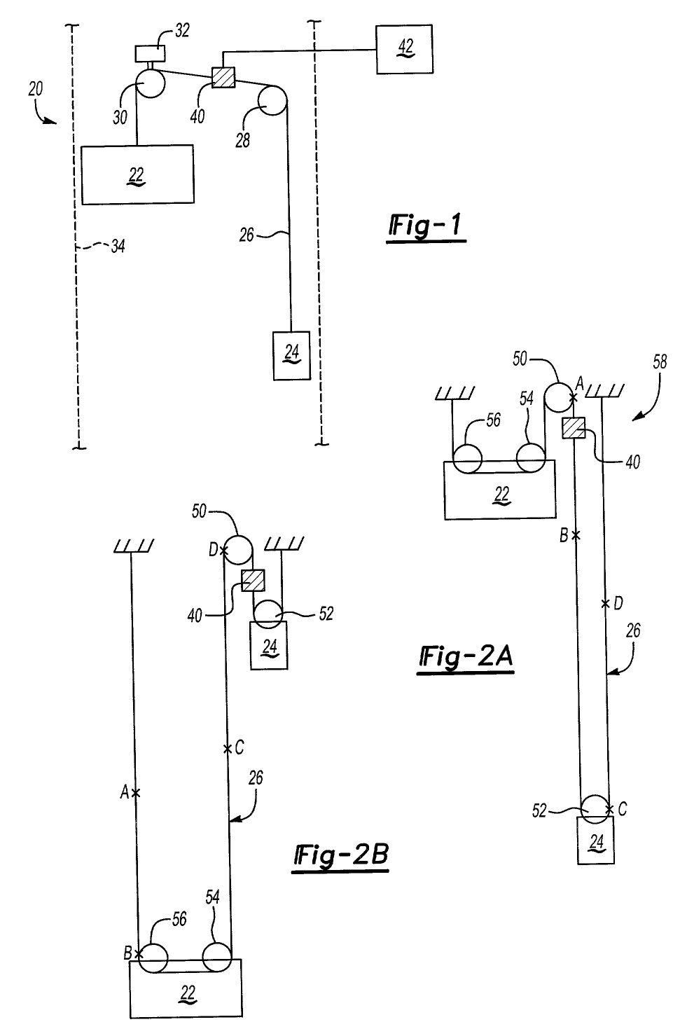

### DETAILED DESCRIPTION OF THE PREFERRED EMBODIMENTS

An elevator system 20 includes a cab 22 that carries passengers between a plurality of landings (not illustrated) within a building. A counterweight 24 is coupled with the cab 22 by at least one rope or belt 26. This description mostly refers to the load bearing portion 26 of the system 20 as a belt, however, this invention is not limited to “belts” in the strictest sense. The terms “rope” and “belt” are considered synonymous and interchangeable for purposes of this specification.

Although those skilled in the art recognize that a plurality of belts may be used, this description refers to a single belt for discussion purposes. The belt 26 preferably includes a plurality of steel cords each having a plurality of strands. Sheaves 28 and 30 guide the belt along a chosen path to move the cab 22 between the various landings. A conventional drive mechanism 32 is associated with the sheave 30 to drive the belt and move the elevator components as desired. The counterweight 24 and cab 22 move within a hoistway (illustrated in phantom at 34) in a conventional manner.

An inspection device 40 is positioned relative to the elevator components to provide information regarding the condition of the belt 26. The information from the inspection device 40 preferably is provided to a controller 42 that processes the information and places that into a usable form for an elevator designer or technician, for example. The controller 42 may be associated with more than one inspection device 40. The controller 42 may be located within an elevator hoistway or positioned elsewhere within a building. Further, it is within the scope of this invention to have the information from the inspection device 40 communicated to a remote location where that information is analyzed or processed appropriately.

The inspection device 40 preferably utilizes the magnetic flux or electrical resistance measurement techniques disclosed in U.S. patent application Ser. No. 09/280,637 (Attorney Docket OT-4465), which was filed on Mar. 29, 1999. The teachings of that specification are incorporated into this description by reference. Other types of inspection devices may be used within the scope of this invention.

This invention includes strategically placing the inspection device 40 relative to the elevator system components to gather information regarding the portion of the belt that is most likely to experience wear or deterioration over time. A variety of factors should be considered when determining the optimum placement of the inspection device. These factors include the number and nature of bends that various sections of the belt experience as the elevator travels in the hoistway, the diameter or size of the sheaves over which the belt bends, distances between the sheaves, the angle of the belt wrapped around the sheaves, and the worst case loading on various sections of the belt. As those skilled in the art will appreciate, these factors are dependent upon several variables, such as elevator roping arrangements, the location of the drive mechanism or machine, the use and placement of deflector sheaves, and the floor within the building at which the worst case car loading conditions typically occur. This invention utilizes one or more of these factors for determining the ideal placement of the inspection device.

In the preferred arrangement, the inspection device 40 is positioned so that the portion of the belt 26 most likely to deteriorate or experience fatigue is always inspected with each full travel of the elevator within the hoistway.

The various factors that are considered preferably are weighted to give appropriate emphasis to the factors that contribute more significantly to belt fatigue. For example, bends over smaller diameter sheaves and shorter distances between sheaves provides a more significant impact than loading. Similarly, reverse bends provide a higher impact than simple bends. Another example is that a reverse bend over a fixed sheave provides more of an impact than a reverse bend over a moving sheave. Given this description, those skilled in the art will be able to determine what factors to account for in a particular situation. Additionally, those skilled in the art who have the benefit of this description will be able to assign appropriate significance or weighting to the various factors for making a proper inspection device placement determination.

The following describes various examples of elevator system arrangements with an ideal location of the inspection device designed according to this invention. Of course, other arrangements are possible where other locations of the inspection device will provide the best results. This invention is not limited to the examples discussed in this specification.

FIG. 2A shows a 2:1 elevator roping arrangement that is over-slung without deflector sheaves. As the cab 22 travels from the top landing to the bottom of the hoistway, section A-B of the belt 26 experiences one 180° simple bend around the fixed traction sheave 50. The belt 26 also experiences one 90° reverse bend around the sheave 52 and one 90° simple bend around each of the moving car sheaves 54 and 56. The point of the belt 26 designated A goes through a relatively quick reverse bend when the elevator cab 22 begins moving at the top of the hoistway. When the cab 22 is at the top of the hoistway 34, belt loading at point A is ½ of the counterweight 24 plus the weight of the section of the belt between the counterweight and the traction sheave 50.

As the cab 22 travels from the bottom of the hoistway toward the top, section C-D experiences one 180° simple bend around the fixed traction sheave 50 (see FIG. 2B). The belt also experiences one 180° reverse bend around the moving counterweight sheave 52. The point of the belt 26 designated D goes through a relatively quick reverse bend when the counterweight starts its motion at the top of the hoistway. At the bottom of the hoistway, the loading at point D is ½ of the fully loaded car 22 plus the weight of the section of the belt between the car and the traction sheave 50.

In the example of FIGS. 2A and 2B, section C-D is likely to deteriorate faster than section A-B because of the more severe loading and bending conditions imposed on that portion of the belt. The location of the inspection device 40, therefore, is such that the entire section C-D is inspected as the elevator travels between the hoistway terminals. In this example, the point of the belt designated D preferably receives particular emphasis from the inspection device 40. In the example of FIGS. 2A and 2B it is most preferred that the inspection device 40 is fixed at a point in the hoistway below the traction sheave 50 on the counterweight side 58.

For purposes of discussion, the belt 26 is considered to have sections A-B and C-D, which were chosen based on the following criteria. When the elevator is at the highest point within the hoistway 34, point A is considered the point where the belt 26 contacts the traction sheave 50 on the counterweight side. This is the point where section A-B begins to bend as the cab 22 begins motion in a down direction. Point C is the point where the belt 26 contacts the counterweight sheave 50 on the counterweight hitch side. This is the point where section C-D begins to bend as the elevator cab 22 begins motion in the down direction.

When the cab 22 is at the lowest landing, point D is the point where the belt 26 contacts the traction sheave 50 on the car side. This is the point where section C-D begins to bend as the elevator cab 22 begins moving in the up direction. Point B is the point where the belt contacts the car sheave on the car hitch side. This is the point where section A-B begins to bend as the cab 22 begins moving in the up direction.

The example of FIGS. 2A and 2B may be modified by including a deflector sheave. If a deflector sheave is included, the inspection device may be placed between the traction sheave 50 and the deflector sheave. Alternatively, the inspection device is positioned as described above (i.e., below the traction sheave 50 on the counterweight side 58).

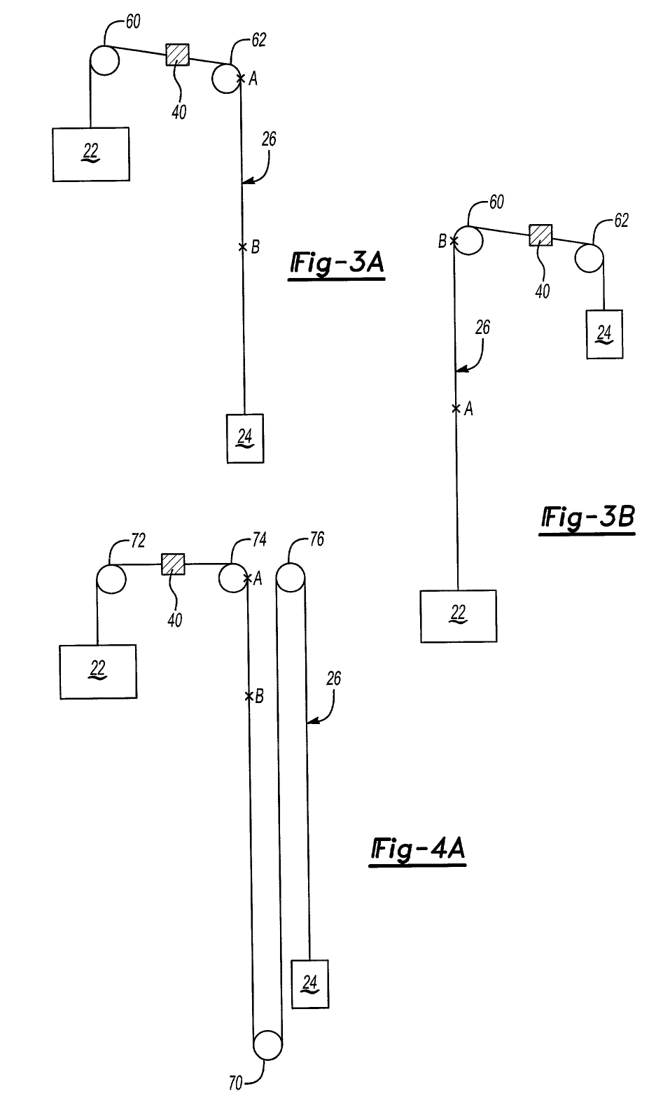

FIGS. 3A and 3B illustrate a 1:1 roping arrangement including a traction sheave 60 and a deflector sheave 62. In this example, the preferred placement of the inspection device 40 is between the traction sheave 60 and the deflector sheave 62. For 1:1 roping arrangements without a deflector sheave, such as is used with a cantilevered car, the inspection device 40 preferably is placed below the traction sheave on the counterweight side.

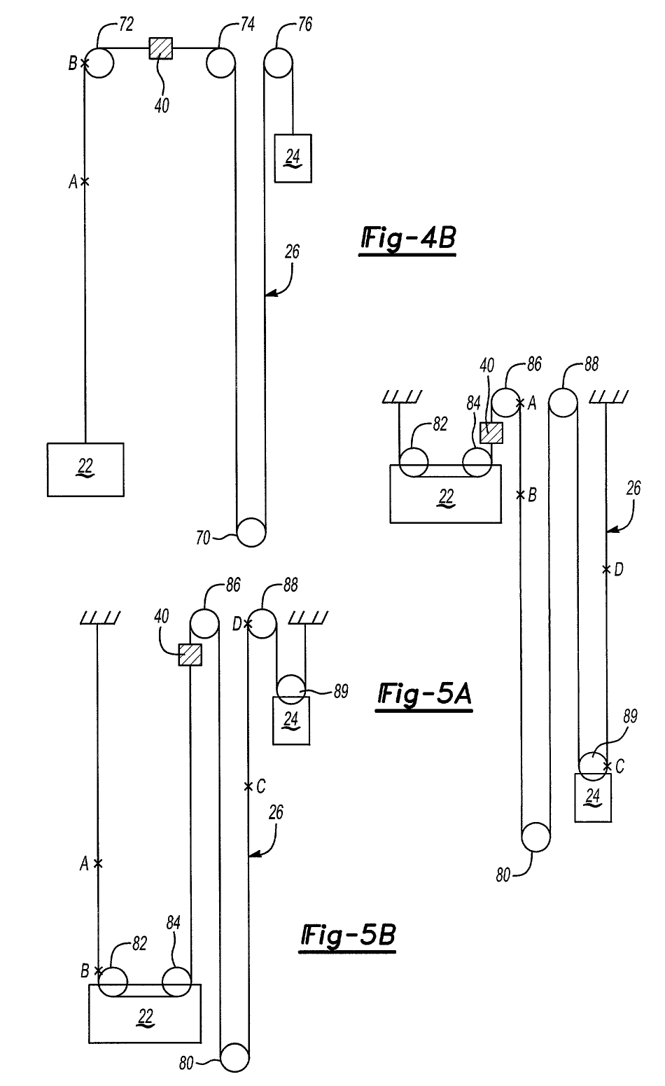

FIGS. 4A and 4B illustrate a 1:1 roping arrangement with the traction sheave 70 below the cab 22. Such arrangements are often referred to as machine-below arrangements. In this example, the inspection device 40 preferably is positioned between deflector sheaves 72 and 74 on the car side.

FIGS. 5A and 5B illustrate a 2:1 roping arrangement where the traction sheave 80 is located below the cab 22 and counterweight 24. This example includes two moving car sheaves 82 and 84, two fixed deflector sheaves 86 and 88 and a moving counterweight sheave 89. The preferred placement of the inspection device 40 is below the fixed deflector sheave 86 on the car side. This permits complete inspection of section A-B, which is the portion most likely to deteriorate in the illustrated arrangement.

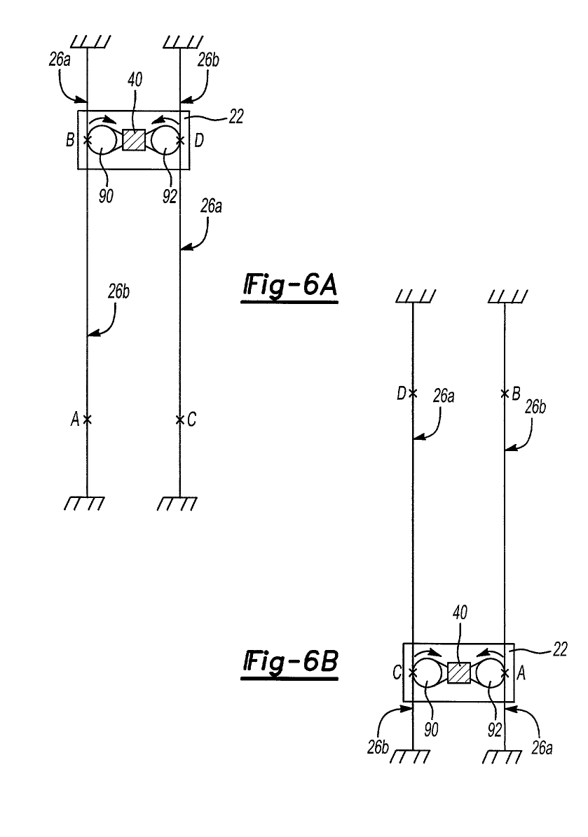

In each of the preceding examples, the inspection device 40 preferably is fixed at a location within the hoistway. In some situations, such as the examples shown in FIGS. 6A and 6B, it is preferred that the inspection device 40 moves with one or more of the elevator components through the hoistway.

The examples shown in FIGS. 6A and 6B includes a rope climbing elevator arrangement. A first belt 26A includes section C-D while a second belt 26B includes section A-B. As the cab 22 travels up or down through the hoistway, sections A-B and C-D experience one simple bend and then a relatively quick reverse bend around the two driven sheaves 90 and 92. Both of the bends are greater than 90°.

The worst case loading condition on the belts is when the cab 22 is at the lowest floor. This typically includes a fully loaded car weight distributed equally between the two belt systems. In this example, the belts will most likely deteriorate quicker around points A and C.

The preferred placement of the inspection device 40 is between the two sheaves 90 and 92 on the car 22. This not only provides for excellent detection of belt deterioration but also has the advantage of including the possibility for inspecting both belts 26A and 26B, simultaneously. Alternatively, two inspection devices 40 can be positioned below each of the sheaves 90 and 92 supported on the car 22.

Given this description, those skilled in the art will be able to take into account the various factors that indicate ideal placement of an inspection device in a particular situation. Variations and modifications to the disclosed embodiments may become apparent to those skilled in the art that do not necessarily depart from the purview and spirit of this invention. The scope of legal protection given to this invention can only be determined by studying the following claims.

1. An elevator system comprising:
a cab;
at least one rope having a plurality of metallic load bearing members associated with the cab;
at least one sheave that guides the rope as the cab moves; and
an inspection device that provides information regarding a condition of a portion of the rope that is most likely to wear.

2. The system of claim 1, wherein the inspection device is at a fixed point relative to the sheave.

3. The system of claim 1, wherein the inspection device is supported to move with the cab.

4. The system of claim 1, wherein the inspection device is positioned to provide information regarding the entire portion of the rope that is most likely to wear each time that the cab travels between chosen locations.

5. A method of inspecting at least one belt in an elevator system where the belt is associated with a cab and is guided by at least one sheave, comprising the steps of:
(A) determining a portion of the belt that is most likely to wear;
(B) positioning an inspection device relative to the belt; and
(C) gathering information regarding a condition of the portion of the belt that is most likely to wear as the cab moves between chosen positions.

6. The method of claim 5, wherein step (A) includes considering at least one of a plurality of system characteristics when determining which portion of the belt is most likely to wear.

7. The method of claim 6, wherein the system characteristics include a number of bends that the belt experiences as the cab travels between locations, dimensions of a sheave along which the belt travels, the manner in which a sheave is supported within the elevator system and an angle of belt wrap around a sheave and a worst case loading on a plurality of portions of the belt.

8. The method of claim 7, including considering several system variables, including an elevator roping arrangement, a position of a drive mechanism, a position of the sheave and a landing at which worst case car loading conditions typically occur.

9. The method of claim 8, including weighing the various factors and determining which of those factors has a higher significance than other factors as part of determining which portion of the belt is most likely to wear.

10. The method of claim 5, including supporting the inspection device in a fixed location relative to the sheave.

11. The method of claim 5, including supporting the inspection device for movement relative to other components of the elevator system.
